(19) United States
(12) Patent Application Publication
(10) Pub. No.: US 2006/0150657 A1
(43) Pub. Date: Jul. 13, 2006

(54) Thermoelectric enhanced HVAC system and method

(75) Inventors: Daniel A. Spurgeon, Washington, IL (US); Mahmoud A. Taher, Peoria, IL (US)

Correspondence Address: CATERPILLAR/FINNEGAN, HENDERSON, L.L.P., 901 New York Avenue, WASHINGTON, DC, 20001-4413, US

(73) Assignee: Caterpillar Inc.

(21) Appl. No.: 11/031,045

(22) Filed: Jan. 10, 2005

(51) Int. Cl. F25B 21/02; F24F 7/00; B60H 1/32; F25D 15/00; F25D 23/12

(52) U.S. Cl. 62/331; 62/244; 62/3.2

(57) ABSTRACT

A heating and cooling system is provided for use on a work machine. The system may include one or more temperature sensors configured to collect environmental temperature information and a compressor-based HVAC unit having a compressor and providing in-cabin climate control based on circulation. The system may also include a thermoelectric HVAC unit to supplement the compressor-based HVAC unit. Further, the system may include a controller configured to control the thermoelectric HVAC unit and the compressor-based HVAC unit based on the environmental temperature information.

### TECHNICAL FIELD

This disclosure relates generally to work machine heating, ventilation, air conditioning (HVAC) systems, and more particularly to thermoelectric enhanced HVAC systems on work machines.

### BACKGROUND

Modern work machines normally are equipped with HVAC systems to control cabin environment conditions. Conventional HVAC systems often rely on the movement of cooled or heated air within a cabin of a work machine. Because the entire cabin needs to be heated or cooled with these systems, conventional HVAC systems are often less efficient. In certain applications, the cabin may be open to the outside such that heating or cooling from conventional HVAC systems may be impractical or even impossible. In addition, the response time of these systems for producing a temperature change in the cabin may be long, especially when the work machine is just started. For example, shortly after starting, the amount of heat produced by the work machine may be inadequate for heating the cabin of the work machine. Conversely, the air conditioning refrigerant may be too warm to provide prompt cooling of the cabin.

Thermoelectric devices have been proposed to reduce the response time for producing a temperature change in the cabin of a vehicle. U.S. Pat. No. 6,510,696 issued to Cuttman, et al. on Jan. 28, 2003, describes a thermoelectric air-condition apparatus with controllable air flows. While the system of the '696 patent may provide air-condition systems using thermoelectric elements, these systems include several shortcomings. For example, these kinds of thermoelectric air-condition systems often use low efficiency bulk thermoelectric materials, do not work in connection with conventional HVAC systems, and do not address overall HVAC requirements for the work machine.

Methods and systems consistent with certain features of the disclosed specification are directed to solving one or more of the problems set forth above.

### SUMMARY OF THE INVENTION

In one embodiment, a heating and cooling system is provided for use on a work machine. The system may include one or more temperature sensors configured to collect environmental temperature information and a compressor-based HVAC unit having a compressor and providing in-cabin climate control based on circulation. The system may also include a thermoelectric HVAC unit to supplement the compressor-based HVAC unit. Further, the system may include a controller configured to control the thermoelectric HVAC unit and the compressor-based HVAC unit based on the environmental temperature information.

Another aspect of the present disclosure includes a method for use in a thermoelectric enhanced HVAC system having a compressor-based HVAC unit and one or more thermoelectric modules on a work machine. The method may include determining an operational mode for the thermoelectric enhanced HVAC system. The method may also include determining an operational status for the compressor-based HVAC unit and supplementing the compressor-based HVAC unit with the one or more thermoelectric modules based on the operational status of the compressor-based HVAC unit.

Yet another aspect of the present disclosure includes a work machine. The work machine may include an operator cabin and a compressor-based HVAC unit configured to provide conditioned air to the cabin. At least one thermoelectric module configured to alter environmental conditions in the cabin may be provided. The work machine may also include a controller configured to selectively operate the compressor-based HVAC unit and the at least one thermoelectric module.

### BRIEF DESCRIPTION OF THE DRAWINGS

The accompanying drawings, which are incorporated in and constitute a part of this specification, illustrate several embodiments and together with the description, serve to explain the principles of the disclosed embodiments. In the drawings:

FIG. 1 is a diagrammatic illustration of an exemplary work machine that may be configured to perform certain functions consistent with certain disclosed embodiments;

FIG. 2A illustrates an exemplary configuration of thermoelectric materials consistent with certain disclosed embodiments;

FIG. 2B illustrates another exemplary configuration of thermoelectric materials consistent with certain disclosed embodiments;

FIG. 2C illustrates another exemplary configuration of thermoelectric materials consistent with certain disclosed embodiments;

FIG. 2D illustrates another exemplary configuration of thermoelectric materials consistent with certain disclosed embodiments;

FIG. 2E illustrates another exemplary configuration of thermoelectric materials consistent with certain disclosed embodiments;

FIG. 2F illustrates another exemplary configuration of thermoelectric materials consistent with certain disclosed embodiments;

FIG. 3 illustrates a block diagram of a thermoelectric enhanced HVAC system on a work machine consistent with certain disclosed embodiments;

FIG. 4 illustrates a functional diagram of a controller of the thermoelectric enhanced HVAC system;

FIG. 5 illustrates a flowchart of an exemplary thermoelectric HVAC unit operation process performed by the controller;

FIG. 6 illustrates a flowchart of an exemplary sleeper thermoelectric HVAC unit operation process performed by the controller; and

FIG. 7 illustrates a flowchart of an exemplary thermoelectric enhanced HVAC system operation process performed by the controller.

### DETAILED DESCRIPTION

Reference will now be made in detail to exemplary embodiments, which are illustrated in the accompanying drawings. Wherever possible, the same reference numbers will be used throughout the drawings to refer to the same or like parts.

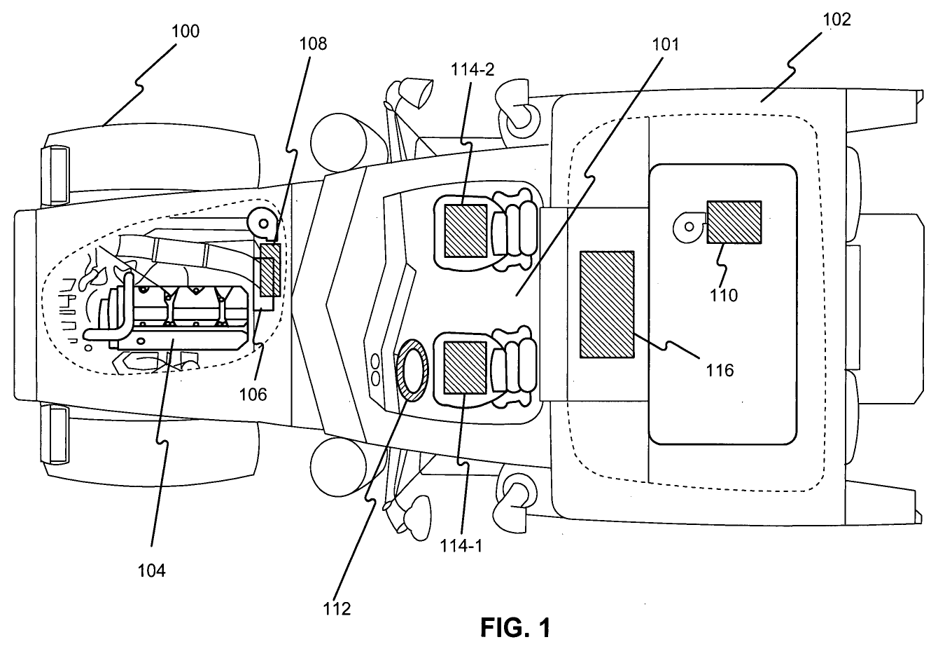

FIG. 1 illustrates several thermoelectric components of a thermoelectric enhanced HVAC system incorporated into a work machine 100. Work machine 100 may refer to any type of fixed or mobile machine that performs some type of operation associated with a particular industry, such as mining, construction, farming, transportation, etc. and operates between or within work environments (e.g., construction site, mine site, power plants, on-highway applications, etc.). Non-limiting examples of mobile machines include commercial machines, such as trucks, cranes, earth moving vehicles, mining vehicles, backhoes, material handling equipment, farming equipment, marine vessels, aircraft, and any type of movable machine that operates in a work environment. Work machine 100 may also refer to any type of automobile or commercial vehicle. Although, as shown in FIG. 1, work machine 100 is an on-highway truck type work machine, it is contemplated that work machine 100 may be any type of work machine. Further, work machine 100 may be a conventionally powered, hybrid electric powered, and/or fuel cell powered work machine.

As shown in FIG. 1, work machine 100 may include a cabin 101, a sleeping compartment 102, an engine 104, a traditional HVAC unit 106, a thermoelectric HVAC unit 108, a sleeper thermoelectric HVAC unit 110, a steering wheel thermoelectric device 112, seat thermoelectric devices 114-1 to 114-2, and a floor thermoelectric device 116. Thermoelectric HVAC unit 108, steering wheel thermoelectric device 112, seat thermoelectric devices 114-1 to 114-2, and floor thermoelectric device 116 may thus be provided to supplement or displace traditional HVAC unit 106.

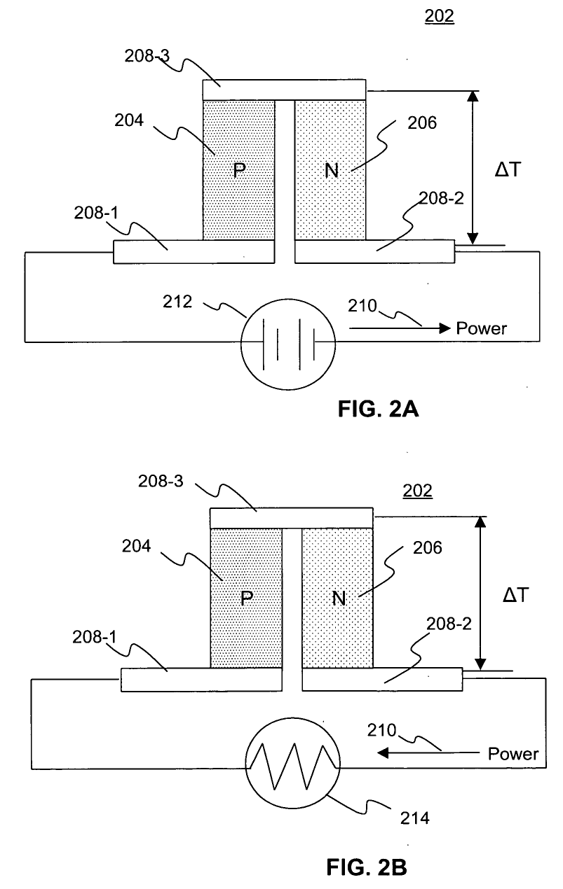

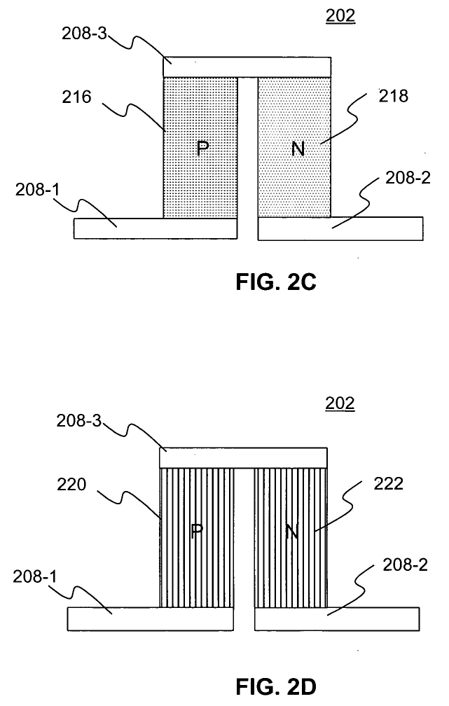

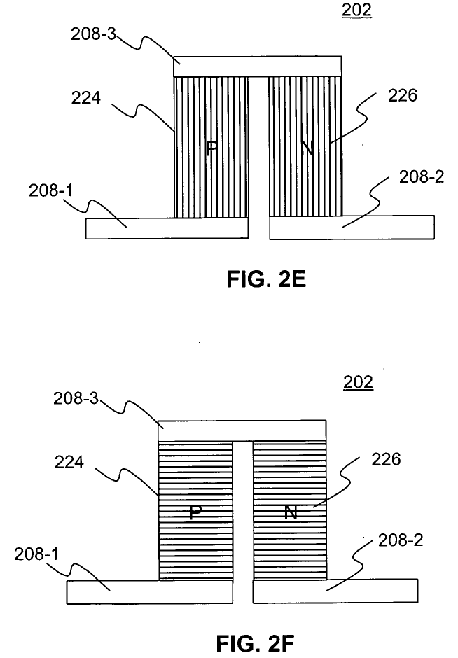

Thermoelectric HVAC unit 108, sleeper thermoelectric HVAC unit 110, steering wheel thermoelectric device 112, seat thermoelectric devices 114-1 to 114-2, and floor thermoelectric device 116 include thermoelectric modules including high efficiency thermoelectric materials. Thermoelectric materials may be operated based on the Seebeck effect or the Peltier effect. FIG. 2A illustrates an exemplary configuration of thermoelectric materials operating based on the Peltier effect. As shown in FIG. 2A, thermoelectric materials may be semiconductors that are packaged in a thermoelectric couple 202. Thermoelectric couple 202 may include a positive-type P element 204 and a negative-type N element 206. Couple 202 may also include junctions 208-1 to 208-3. When electrical power 210 from a current source 212 is passed through thermoelectric couple 202, a temperature gradient ΔT may be generated across junctions 208-1 and 208-2 and junctions 208-3 of thermoelectric couple 202. Such a phenomenon is known as the Peltier effect. The polarity of the temperature gradient (i.e., which junction or junctions have a high temperature) may be determined by the polarity of current source 212 providing power 210 to thermoelectric couple 202.

Conversely, as shown in FIG. 2B, electrical power 210 may be generated through an electrical load 214 if a temperature difference ΔT is maintained between the junctions 208-1 and 208-2 and junction 208-3 of thermoelectric couple 202. Such a temperature gradient may be maintained by providing a heat source at one junction and a heat sink at the other junctions (a phenomenon known as the Seebeck effect).

The effectiveness of a thermoelectric material in converting electrical energy to heating or cooling energy (i.e., coefficient of performance “COP”), or converting heat energy to electrical energy (conversion efficiency “η”) depends on the thermoelectric material's figure of merit termed “Z” and the average operating temperature “T”. Z is a material characteristic that is defined as:

$$Z = \frac{{S}^{2} σ}{λ} ,$$

where S is the Seebeck coefficient of the material, σ is the electrical conductivity of the material, and λ is the thermal conductivity of the material.

Because Z changes as a function of temperature, Z may be reported along with the temperature T, at which the properties are measured. Thus, the dimensionless product ZT may be used instead of Z to reflect the effectiveness of the thermoelectric material. To improve the COP or η of thermoelectric materials, an increase in ZT may be necessary.

From the definition of Z, an independent increase in the Seebeck coefficient and/or electrical conductivity, or an independent decrease in the thermal conductivity may contribute to a higher ZT. Conventional low ZT thermoelectric materials, also known as bulk thermoelectric materials, may have ZT values that do not exceed one. Newly developed thermoelectric materials with low dimensional structures have demonstrated a higher figure of merit ZT, which may approach 5 or more. These materials may include zero-dimensional quantum dots, one-dimensional nano wires, two-dimensional quantum well and superlattice thermoelectric structures.

While bulk thermoelectric materials may be used in thermoelectric HVAC units, in certain embodiments, high ZT thermoelectric materials may also be used. High efficiency thermoelectric materials that may have ZT values between 0.5 and 10 may be provided consistent with disclosed embodiments. In one embodiment, as shown in FIG. 2C, couple 202 may include a P element 216 and an N element 218 that may be made of zero-dimensional quantum dots of lead-tin-selenium-telluride or other thermoelectric materials. In another embodiment, as shown in FIG. 2D, thermoelectric couples 202 may include a P element 220 and an N element 222 that may be made of one-dimensional nano wires of bismuth-antimony or other thermoelectric materials. In another embodiment, as shown in FIG. 2E, thermoelectric couple 202 may include a P element 224 and an N element 226 that may be made of two-dimensional quantum well or superlattice thermoelectric structures of silicon-germanium, boron-carbon or other thermoelectric materials.

As explained above, thermoelectric couple 202 may include thermoelectric materials having low dimensional structures, such as two-dimensional quantum well materials. Arrangement of the low dimensional structures relative to the flow of heat may be in-plane, as shown in FIG. 2E. Alternatively, the arrangement of the low dimensional structures relative to the flow of heat may also be cross-plane, as shown in FIG. 2F.

It is understood that the structures and thermoelectric materials in couple 202 are exemplary and not intended to be limiting. Other structures and thermoelectric materials may be included without departing from the principle and scope of disclosed embodiments. For example, in certain embodiments, thermoelectric couple 202 used by thermoelectric HVAC units may include P elements with different structures from N elements. For instance, the P elements may be made of zero-dimensional quantum dots, while the N elements may be made of two-dimensional quantum well or superlattice thermoelectric structures.

Returning to FIG. 1, cabin 101 may be any type of work machine operation space. For instance, cabin 101 may be a cab of an on-highway truck. Cabin 101 may include a variety of different equipment, such as a steering wheel, seats, dash board, and one or more vents associated with HVAC systems. Cabin 101 may be closed or open to the outside environment. Even when cabin 101 is open, heating and/or cooling may be still desirable under certain conditions. Traditional HVAC unit 106, however, may be unable to provide effective heating and/or cooling when cabin 101 is open.

Sleeping compartment 102 may be available on certain types of work machines, such as on-highway trucks. Sleeping compartment 102 provides an operator of work machine 100 a place to rest. When the operator is in compartment 102, engine 104 may be turned off. To condition air in sleeping compartment 102, the operator may use electric equipment powered via high voltage batteries or back up generators, such as sleeper thermoelectric HVAC unit 110.

Engine 104 may be any type of engine that provides power to work machine 100 and/or to traditional HVAC unit 106, thermoelectric HVAC unit 108, and other thermoelectric-based modules. For example, engine 104 may be an internal combustion engine. Engine 104 may also provide heating through traditional HVAC unit 106 to cabin 101 and/or sleeping compartment 102.

Traditional HVAC unit 106 may be any type of on-board HVAC unit equipped with a compressor and relying on air circulation for climate control. Compressor-based traditional HVAC unit 106 may include control sections accepting control settings for its operation. These settings may be controlled by an operator via an input device (not shown) or may be controlled by a controller automatically. These settings may include operational modes, such as a heating mode, cooling mode, or fan mode, and various temperature settings for heating and/or cooling modes. Traditional HVAC unit 106 may be powered by any appropriate type of power source on work machine 100. For instance, traditional HVAC unit 106 may be powered by an engine belt drive, an engine gear drive, an electric motor, hydraulic, etc. Traditional HVAC unit 106 may also be capable of providing effective heating and/or cooling for cabin 101 and/or sleeping compartment 102.

Thermoelectric HVAC unit 108 may be any type of thermoelectric HVAC unit that is suitable for use on work machine 100. Particularly, as explained above, thermoelectric HVAC unit 108 may include high efficiency thermoelectric materials such as superlattice structured thermoelectric materials or quantum dot superlattice thermoelectric materials. Blowers may also be included to provide heated or cooled air generated by thermoelectric HVAC unit 108 to cabin 101 and/or sleeping compartment 102 through the various vents.

Thermoelectric HVAC unit 108 may be coupled with traditional HVAC unit 106 such that they may use the same set of vents, such as vents in sleeping compartment 102, dash vents, defroster vents, floor vents, etc., to provide heated or cooled air to cabin 101 and/or sleeping compartment 102. Sleeper thermoelectric HVAC unit 110 may be configured for providing heating and cooling to sleeping compartment 102. Sleeper thermoelectric HVAC unit 110 may be connected to high voltage batteries, a generator, and/or an auxiliary power unit (APU) so that sleeper thermoelectric HVAC unit 110 may operate even when engine 104 is turned off.

Steering wheel thermoelectric device 112 may be incorporated into a steering wheel of work machine 100. For example, thermoelectric device 112 may include one or more layers of thin films of high efficiency thermoelectric materials fixed on a ring portion of a steering wheel. The ring portion of the steering wheel may include a circumferential portion of a steering wheel which an operator grips.

Seat thermoelectric devices 114-1 to 114-2 may include thin high efficiency thermoelectric materials incorporated into seats of work machine 100. Seat thermoelectric devices 114-1 to 114-2 may provide a desired seat temperature for the operator and passengers of work machine 100, even when cabin 101 may be open to an outside environment. Similarly, floor thermoelectric device 116 may include high efficiency thermoelectric materials incorporated into the floor of cabin 101 and/or sleeping compartment 102. Certain areas of floor may be kept at a desired temperature even when the air temperature of cabin 101 cannot be maintained at a desired level, such as when cabin 101 is open.

The number of thermoelectric devices included in work machine 100 are exemplary only and not intended to be limiting. Any number of thermoelectric devices may be incorporated into the work machine without departing from the principle and scope of the disclosed embodiments.

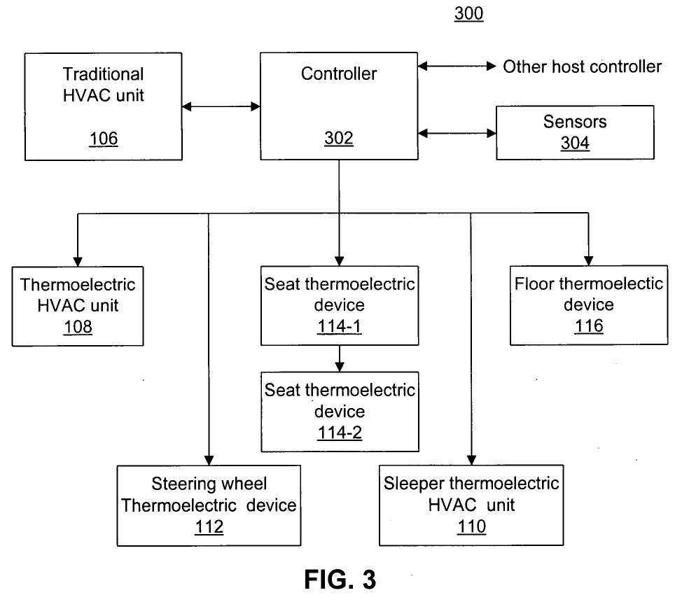

Thermoelectric HVAC unit 108, sleeper thermoelectric HVAC unit 110, steering wheel thermoelectric device 112, seat thermoelectric devices 114-1 to 114-2, and floor thermoelectric device 116 may be operated directly by an operator through an operator input device (not shown). For example, the operator may use the input device or a switch (not shown) to selectively operate any of the HVAC units including traditional HVAC unit 106 or thermoelectric devices either separately or in any appropriate combination. However, direct operation by the operator may require attention from the operator or may be difficult for untrained operators. In certain embodiments, these thermoelectric modules may be controlled by a control system such that all thermoelectric modules and traditional HVAC unit 106 can be integrated into a thermoelectric enhanced HVAC system that operates automatically to provide enhanced and efficient HVAC capabilities. FIG. 3 provides a block diagram of an exemplary thermoelectric enhanced HVAC system 300.

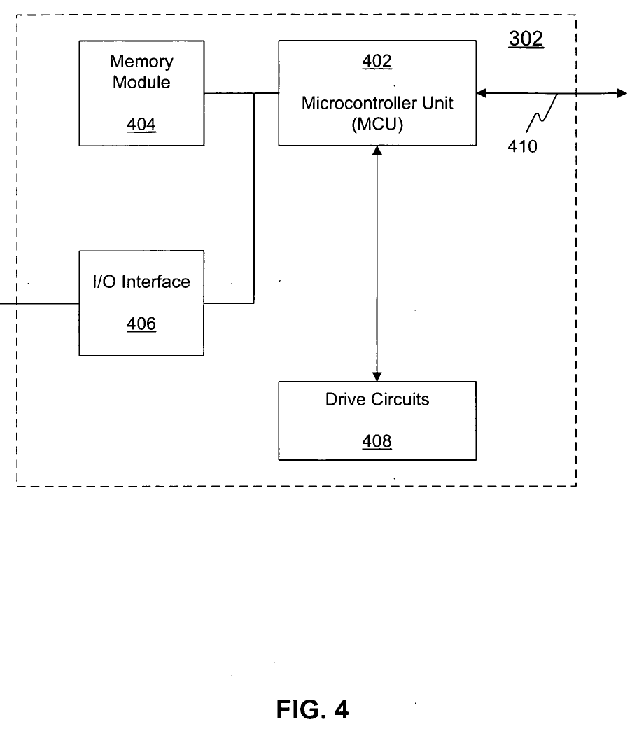

As shown in FIG. 3, thermoelectric enhanced HVAC system 300 may include a controller 302, various temperature sensors 304, traditional HVAC unit 106, thermoelectric HVAC unit 108, sleeper thermoelectric HVAC unit 110, steering wheel thermoelectric device 112, seat thermoelectric devices 114-1 to 114-2, and floor thermoelectric device 116. Controller 302 may be configured to execute certain software programs to systematically control the operation of thermoelectric enhanced HVAC system 300. An exemplary functional block diagram of controller 302 is shown in FIG. 4.

As shown in FIG. 4, controller 302 may include a microcontroller unit (MCU) 402, a memory module 404, I/O interface 406, drive circuits 408, and a bus 410. Other components may also be included in controller 302. Additionally, controller 302 may coincide with an electronic control unit (ECU) (not shown) for work machine 100.

MCU 402 may be configured as a separate processor module dedicated to control enhanced HVAC system 300. Additionally or alternatively, MCU 402 may be configured as a shared processor module performing other functions unrelated to enhanced HVAC system 300. MCU 402 may include one or more microcontrollers with on-board memory, network ports (e.g., controller area network (CAN) ports), pulse width modulation (PWM) ports (not shown), and I/O ports (not shown). Drive circuits 408 may include any drive circuits to drive thermoelectric modules under the control of MCU 402. Further, MCU 402 may also be configured as a microprocessor supported by various memory modules and peripheral devices. In certain embodiments, MCU 402 may communicate with other controllers (not shown) via bus 410 under predetermined protocols, such as J1939. Other communication protocols and bus types, however, may also be used.

Memory module 404 may include one or more memory devices including, but not limited to, a ROM, a flash memory, a dynamic RAM, and a static RAM. Memory module 404 may be configured to store information used by MCU 402. Further, memory module 404 may be either external or internal to MCU 402. I/O interfaces 406 may include one or more input/output interface devices receiving data (e.g., control signals) from MCU 402 and sending data (e.g., interrupt signals) to MCU 402. I/O interfaces 406 may also be connected to various temperature sensors 304 or other components (not shown).

Returning to FIG. 3, temperature sensors 304 may include any type of temperature sensors incorporated in work machine 100 to provide temperature data on different locations inside and/or outside work machine 100. For example, temperature sensors 304 may be used to obtain outside air temperature and air temperature inside cabin 101 and/or sleeping compartment 102. Temperature sensors 304 may also be used to obtain other temperature data such as engine temperature, coolant temperature, cooling and/or heating temperature of traditional HVAC unit 106, etc. Various temperature data, such as inside and outside temperature, may be also displayed on a display device (not shown) for an operator of work machine 100. The operator may also choose to manually control various HVAC units and/or devices through an input device (not shown) or let controller 302 automatically control the operation of thermoelectric enhanced HVAC system 300.

When automatically controlling the operation of thermoelectric enhanced HVAC system 300, controller 302 can make various decisions based on the temperature data provided by temperature sensors 304 and the operation status of various HVAC systems by executing certain software programs stored in memory module 404. For example, if cabin temperature is low, controller 302 may decide to operate thermoelectric enhanced HVAC system 300 in heating mode. Controller 302 may further determine whether to use traditional HVAC unit 106 or use thermoelectric HVAC unit 108 or both. If thermoelectric HVAC unit 108 is to be used, controller 302 may also determine the polarity and magnitude of the voltage to be applied to HVAC unit 108. If traditional HVAC unit 106 is to be used, controller 302 may also determine settings for traditional HVAC unit to reach desired temperature.

Controller 302 may also decide to operate traditional HVAC unit 106 and thermoelectric HVAC unit 108 independently. That is, controller 302 may decide to operate only one of traditional HVAC unit 106 and thermoelectric HVAC unit 108. Alternatively, controller 302 may decide to operate traditional HVAC unit 106 and thermoelectric HVAC unit 108 together such that thermoelectric HVAC unit 108 can supplement traditional HVAC unit 106, especially in situations where traditional HVAC unit 106 may be inefficient. In certain situations, to decrease response time, for example, thermoelectric HVAC unit 108 may be operated in conjunction with traditional HVAC unit 106 and may be turned off after traditional HVAC unit 106 becomes fully operational.

Controller 302 may also control other thermoelectric modules, such as steering wheel thermoelectric device 112, seat thermoelectric devices 114-1 to 114-2, and floor thermoelectric device 116 either separately or in conjunction with the operation of the HVAC units. For example, if cabin 101 is closed, steering wheel thermoelectric device 112, seat thermoelectric devices 114-1 to 114-2, and floor thermoelectric device 116 may be controlled based on inside air temperature, which may be controlled by traditional HVAC unit 106 and/or thermoelectric HVAC unit 108. On the other hand, if cabin 101 is open, steering wheel thermoelectric device 112, seat thermoelectric devices 114-1 to 114-2, and floor thermoelectric device 116 may be operated based on the outside temperature and/or the inside temperature.

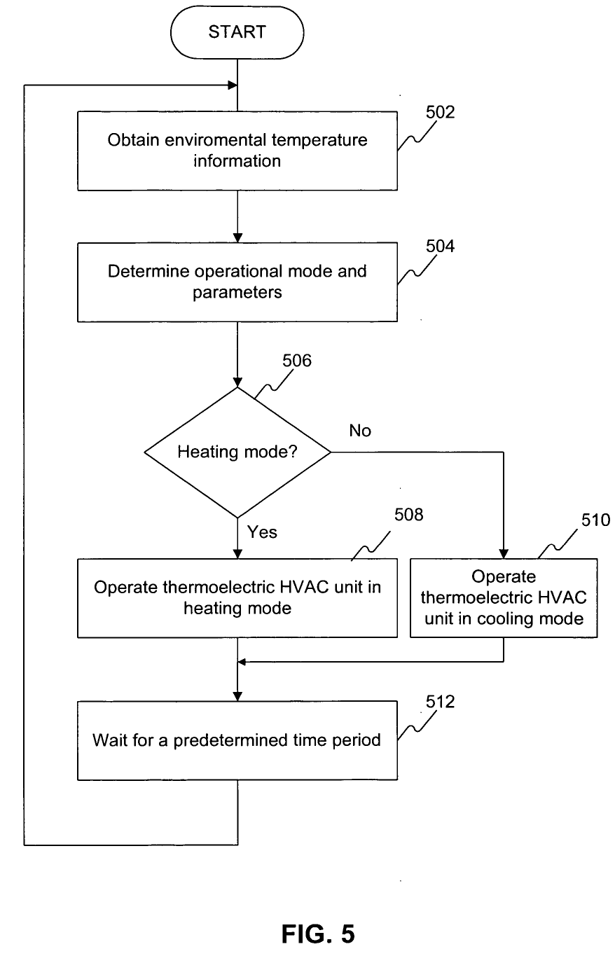

FIG. 5 illustrates an exemplary operation process of thermoelectric HVAC unit 106 performed by controller 302. As shown in FIG. 4, at the beginning of the process, controller 302 may obtain environmental temperature information through temperature sensors 304 (step 502). The environmental temperature information may include inside and/or outside air temperature. Controller 302 may then determine an operational mode and associated parameters based on the temperature information (step 504). For example, if the inside temperature is lower than a preset heating temperature value, controller 302 may determine that heating may be provided to increase the inside temperature. On the other hand, if the inside temperature is higher than a preset cooling temperature value, controller 302 may determine that cooling may be provided to decrease the inside temperature. A temperature difference between the inside temperature and the desired temperature may also be determined by controller 302 in order to calculate a magnitude of the voltage to be applied to thermoelectric materials within thermoelectric HVAC unit 108.

If controller 302 decides to operate thermoelectric HVAC unit 108 in heating mode (step 506; yes), controller 302 may perform various operational steps to operate thermoelectric HVAC unit 108 (step 508). These operational steps may include applying a voltage of calculated magnitude and of selected polarity. On the other hand, if controller 302 decides to operate thermoelectric HVAC unit 108 in cooling mode (step 506; no), controller 302 may perform certain operational steps to operate thermoelectric HVAC unit 108 in cooling mode (step 510). Controller 302 may wait for a predetermined time period (step 512) before the process returns to step 502.

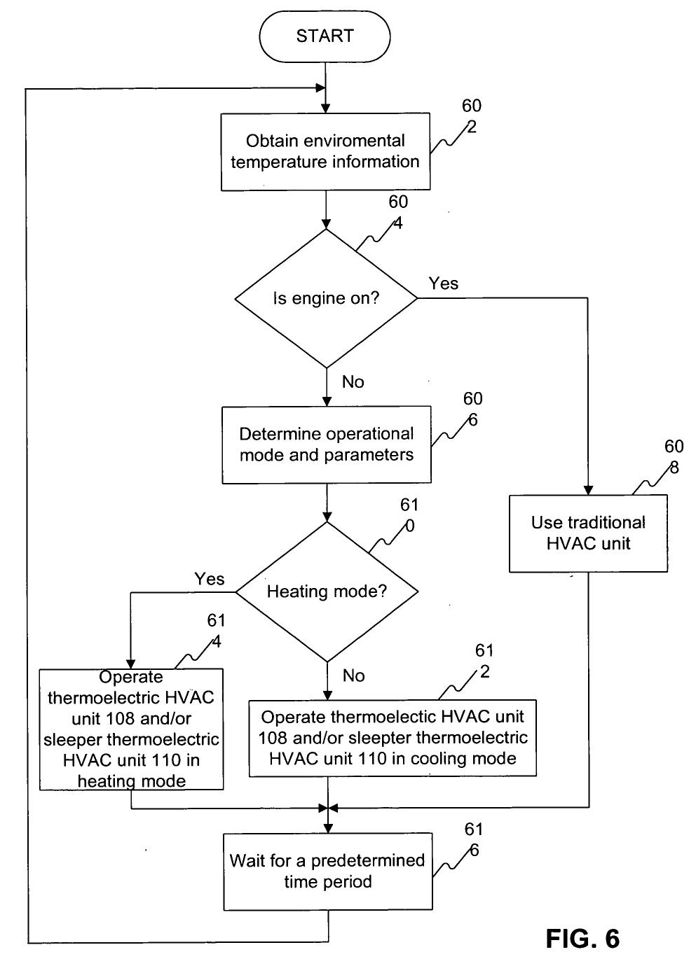

Thermoelectric HVAC unit 108 and sleeper thermoelectric HVAC unit 110 may be operated when work machine 100 is not in operation. FIG. 6 illustrates an exemplary thermoelectric HVAC unit 108 and sleeper thermoelectric HVAC unit operation process performed by controller 302. As shown in FIG. 6, at the beginning of the process, controller 302 may obtain environmental temperature information (step 602). The environmental temperature information may include outside air temperature, temperature in sleeping compartment 102, and/or the temperature in cabin 101. Controller 302 may also determine if engine 104 is operational (step 604). If engine 104 is operational (step 604; yes), controller 302 may decide to use traditional HVAC 106 instead of thermoelectric HVAC unit 108 and/or sleeper thermoelectric HVAC unit 110 (step 608). If thermoelectric HVAC unit 108 and/or sleeper thermoelectric HVAC unit 110 is not turned on, controller 302 may keep it turned off. If thermoelectric HVAC unit 108 and/or sleeper thermoelectric HVAC unit 110 has been already turned on, controller 302 may decide to turn it off.

On the other hand, if engine 104 is not operational (step 604; no), controller 302 may determine an operational mode and parameters for thermoelectric HVAC unit 108 or sleeper thermoelectric HVAC unit 110 based on the temperature information (step 606). For example, if the temperature inside cabin 101 and/or sleeping compartment 102 is lower than a preset heating temperature value, controller 302 may determine that heating may be provided to increase the temperature inside cabin 101 and/or sleeping compartment 102. On the other hand, if the temperature inside cabin 101 and/or sleeping compartment 102 is higher than a preset cooling temperature value, controller 302 may determine that cooling may be provided to decrease the temperature inside cabin 101 and/or sleeping compartment 102. A temperature difference between the temperature inside cabin 101 and/or sleeping compartment 102 and the preset temperature may also be determined by controller 302 in order to calculate a magnitude of the voltage to be applied to thermoelectric materials within thermoelectric HVAC unit 108 and/or sleeper thermoelectric HVAC unit 110.

If controller 302 decides to operate thermoelectric HVAC unit 108 and/or sleeper thermoelectric HVAC unit 110 in heating mode (step 610; yes), controller 302 may then perform various operational steps to operate thermoelectric HVAC unit 108 and/or sleeper thermoelectric HVAC unit 110 (step 614). On the other hand, if controller 302 decides to operate thermoelectric HVAC unit 108 and/or sleeper thermoelectric HVAC unit 110 in cooling mode (step 610; no), controller 302 may then perform certain operational steps to operate thermoelectric HVAC unit 108 and/or sleeper thermoelectric HVAC unit 110 in cooling mode (step 612). Further, controller 302 may wait for a predetermined time period (step 616) before the process starts over again.

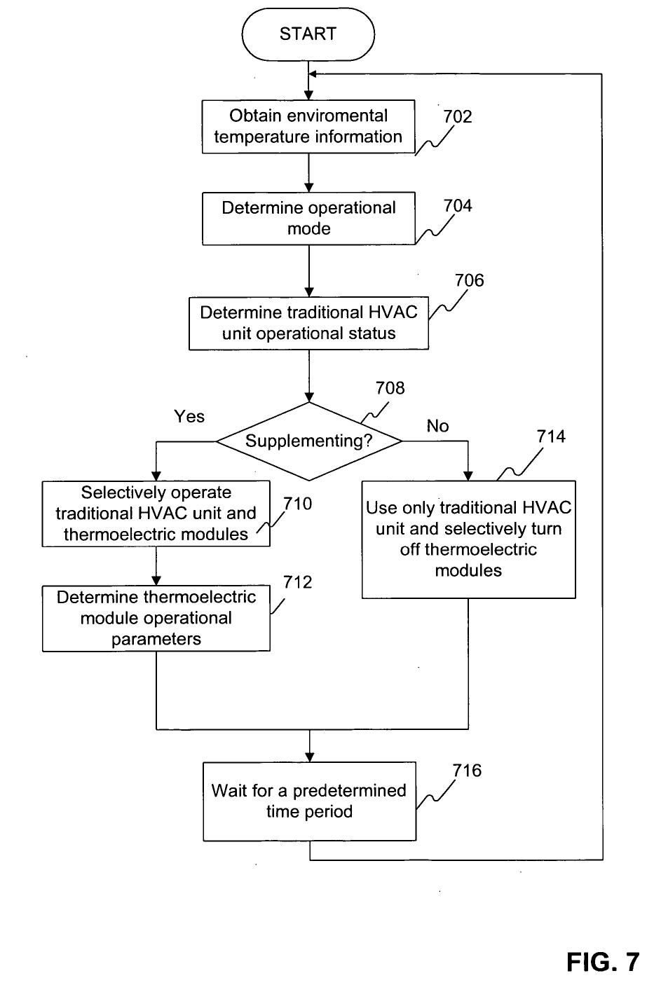

As explained above, controller 302 may also operate both traditional HVAC unit 106 and thermoelectric HVAC unit 108 such that thermoelectric HVAC unit 108 may supplement traditional HVAC unit 106. FIG. 7 illustrates an exemplary thermoelectric enhanced HVAC system operation process performed by controller 302.

As shown in FIG. 7, at the beginning of the process, controller 302 may obtain environmental temperature information through temperature sensors 304 (step 702). Similarly, controller 302 may determine an operational mode based on the temperature information (step 704). For example, the operational mode may include heating, cooling, and/or ventilating (e.g., using air outside cabin 101 if outside temperature is desirable). If a heating or cooling mode is determined, controller 302 may determine the operational status of traditional HVAC unit 106 (step 706). In certain embodiments, operational status may include temperature information about an AC refrigerant cooled by a compressor of traditional HVAC unit 106 and/or engine coolant temperature that may be used for heating. Operational status may also include other information about conditions under which traditional HVAC unit 106 is operating. For example, traditional HVAC unit 106 may be operating while cabin 101 is open or while work machine is running idle. Under these conditions, the extra load on engine 104 for heating and/or cooling may cause additional and/or hotter exhaust from engine 104. Such extra exhaust may be beyond certain regulatory limitations.

Once the operational status is determined, controller 302 may decide whether supplementing is desirable (step 708). For instance, supplementing may be desired if work machine 100 has just started and a long response time may be needed for proper operation of traditional HVAC unit 106. Controller 302 may estimate a response time and may further determine whether the response time is longer than a predetermined threshold response time. Based on the determination, controller 302 may operate thermoelectric HVAC unit 108 to supplement traditional HVAC unit 106.

In certain embodiments, steering wheel thermoelectric device 112, seat thermoelectric devices 114-1 to 114-2, and/or floor thermoelectric device 116 may be used to supplement or even displace traditional HVAC unit 106 to provide point-specific heating and cooling without relying on air circulation inside cabin 101. In other embodiments, if traditional HVAC unit 106 is operating while work machine 100 or engine 104 is running idle, controller 302 may also decide that thermoelectric HVAC unit 106 may supplement or replace traditional HVAC unit 106. Those skilled in the art may recognize other conditions under which supplementing or displacing traditional HVAC unit 106 with thermoelectric modules may be desirable. Further, thermoelectric HVAC unit 108, together with sleeper thermoelectric HVAC unit 110, steering wheel thermoelectric device 112, seat thermoelectric devices 114-1 to 114-2, and floor thermoelectric device 116, may replace traditional HVAC unit 106 to form an all thermoelectric HVAC system.

Based on the operational status information, if controller 302 decides that supplementing is desirable (step 708; yes), controller 302 may then selectively operate traditional HVAC unit 106 and other thermoelectric modules (step 710). For example, controller may operate traditional HVAC unit 106 supplemented by thermoelectric HVAC unit 108 and/or steering wheel thermoelectric device 112, seat thermoelectric devices 114-1 to 114-2, and floor thermoelectric device 116. Or, controller 302 may switch on thermoelectric HVAC unit 108 and switch off traditional HVAC unit 106. Further, controller 302 may operate any combination of steering wheel thermoelectric device 112, seat thermoelectric devices 114-1 to 114-2, and floor thermoelectric device 116.

Controller 302 may further determine operational parameters for thermoelectric modules selected to be operative (step 712). Operation parameters such as the polarity and magnitude of the voltage to be applied to the thermoelectric materials of the various thermoelectric modules may be calculated based on a temperature difference between the present measured temperature and a desired temperature.

On the other hand, if controller determines that no supplementing is desirable (step 708; no), controller 302 may operate only traditional HVAC unit 106 (step 714). If thermoelectric HVAC unit 108 and other thermoelectric modules are in operation, controller 302 may turn off thermoelectric HVAC unit 108 and other thermoelectric modules. Controller 302 may further wait for a predetermined time period before starting the same process again (step 716).

### INDUSTRIAL APPLICABILITY

Because thermoelectric modules may provide near instantaneous changes in temperature through the application of appropriate voltages, thermoelectric modules may provide suitable additions and/or alternatives to traditional HVAC units, especially those that may include long response times. By selectively operating steering wheel thermoelectric devices, seat thermoelectric devices, and floor thermoelectric devices, instantaneous and point-specific heating and/or cooling may be provided to operators of work machines. Particularly, when a cabin in a work machine is open to the outside environment or at the beginning of operation of the work machine, such heating and/or cooling may be impractical or impossible using a traditional HVAC unit and relying on circulation of air within the cabin. Efficient heating and/or cooling of the steering wheel may provide added comfort for an operator and may even encourage better grip on the wheel during operation. This point-specific heating and/or cooling may not be available via traditional HVAC units.

The disclosed methods and systems may be incorporated in any vehicles or work machines where it would be desirable to provide an HVAC system with a rapid response time and effective point specific heating and cooling. The disclosed methods and systems also provide heating and cooling capabilities under various conditions, such as when the vehicle or work machine include an open cabin, or when the vehicle or work machine is idling.

Vehicle manufacturers and HVAC system manufacturers may use the disclosed methods and systems to choose any combination of traditional HVAC unit, thermoelectric HVAC unit, and other thermoelectric modules to achieve desirable heating and cooling results.

Those skilled in the art will recognize that the processes described above are exemplary only and not intended to be limiting. Other processes may be created, steps in the described processes may be removed or modified, the order of these steps may be changed, and/or other operation steps may be added without departing from the principle and scope of disclosed embodiments.

What is claimed is:

1. A heating and cooling system for use on a work machine, comprising:
one or more temperature sensors configured to collect environmental temperature information;
a compressor-based HVAC unit having a compressor and providing in-cabin climate control based on circulation;
a thermoelectric HVAC unit to supplement the compressor-based HVAC unit; and
a controller configured to control the thermoelectric HVAC unit and the compressor-based HVAC unit based on predetermined information.

2. The system according to claim 1, further including:
a plurality of air conduits in fluid communication with both the compressor-based HVAC unit and the thermoelectric HVAC unit.

3. The system according to claim 1, wherein the predetermined information includes at least one of environmental information, sensor inputs, and operator inputs:

4. The system according to claim 1, further including:
a first thermoelectric device incorporated into an operator input device of the work machine;
one or more second thermoelectric devices incorporated into one or more seats of the work machine; and
one or more third thermoelectric devices incorporated into at least one area of the work machine floor.

5. The system according to claim 4, wherein the operator input device is a steering wheel.

6. The system according to claim 4, further including:
a thermoelectric HVAC unit associated with a sleeping compartment of the work machine.

7. The system according to claim 1, wherein the thermoelectric HVAC unit includes a low dimensional thermoelectric material.

8. The system according to claim 7, wherein the low dimensional thermoelectric material is a zero-dimensional quantum dots thermoelectric material.

9. The system according to claim 7, wherein the low dimensional thermoelectric material is a one-dimensional nano wire thermoelectric material.

10. The system according to claim 7, wherein the low dimensional thermoelectric material is a two-dimensional quantum well thermoelectric material.

11. A method for use in a thermoelectric enhanced heating, ventilation, air conditioning (HVAC) system having a compressor-based HVAC unit and one or more thermoelectric modules on a work machine, comprising:
determining an operational mode for the thermoelectric enhanced HVAC system;
determining an operational status for the compressor-based HVAC unit; and
supplementing the compressor-based HVAC unit with the one or more thermoelectric modules based on the operational status of the compressor-based HVAC unit.

12. The method according to claim 11, wherein the determining an operational mode further includes:
obtaining environmental temperature information; and
determining the operational mode for the thermoelectric enhanced HVAC system based on the environmental temperature information;

13. The method according to claim 11, wherein the determining an operational status further includes:
determining whether an engine coolant temperature of the work machine is above a predetermined heating temperature.

14. The method according to claim 11, wherein the determining an operational status further includes:
determining whether a refrigerant temperature of the compressor-based HVAC unit is below a predetermined cooling temperature.

15. The method according to claim 11, wherein the determining an operational status further includes:
determining whether a cabin of the work machine is closed or open to outside environment.

16. The method according to claim 11, wherein the determining an operational status further includes:
determining whether an engine is running idle or at cruise speed.

17. The method according to claim 11, wherein determining further includes:
estimating a response time of the compressor-based HVAC unit to reach a desired in-cabin air temperature; and
comparing the response time with a predetermined threshold to determine whether to supplement the compressor-based HVAC unit.

18. The method according to claim 17, further including:
turning off the thermoelectric HVAC unit after the desired in-cabin air temperature is reached; and
continuing to operate the compressor-based HVAC unit to maintain the desired in-cabin air temperature.

19. The method according to claim 16, further including:
switching between the thermoelectric HVAC unit and the compressor-based HVAC unit according to engine operational status.

20. The method according to claim 11, wherein the one or more thermoelectric modules include:
a thermoelectric HVAC unit;
a steering wheel thermoelectric device;
one or more seat thermoelectric devices; and
one or more floor thermoelectric devices.

21. A method for operating at least one thermoelectric module within a thermoelectric enhanced HVAC system having a compressor-based HVAC unit, comprising:
obtaining environmental temperature information;
determining an operational mode for the at least one thermoelectric module based on the environmental temperature information;
determining a polarity and magnitude of a voltage to be applied to thermoelectric materials within the at least one thermoelectric module; and
applying the voltage having the determined polarity and magnitude to the thermoelectric materials within the at least one thermoelectric module.

22. The method according to claim 21, further including:
periodically checking an operational status of the compressor-based HVAC unit; and
selectively operating the at least one thermoelectric module and the compressor-based HVAC unit based on the operational status.

23. The method according to claim 21, wherein the at least one thermoelectric module includes thermoelectric materials with a figure of merit ZT between 0.5 and 10.

24. A control system of a work machine for use in a thermoelectric enhanced HVAC system, comprising:
a compressor-based HVAC unit;
at least one thermoelectric HVAC unit, and a controller configured to perform operations to:
obtain environmental temperature information from one or more sensors;
determine an operational mode for the thermoelectric enhanced HVAC system based on the environmental temperature information;
determine an operational status for the compressor-based HVAC unit; and
supplement, based on the operational status of the compressor-based HVAC unit, operation of the compressor-based HVAC unit by operating the at least one thermoelectric HVAC unit.

25. The control system according to claim 24, wherein the at least one thermoelectric HVAC unit includes:
a thermoelectric HVAC unit;
a steering wheel thermoelectric device;
one or more seat thermoelectric devices; and
one or more floor thermoelectric devices.

26. A work machine, comprising:
an operator cabin;
a compressor-based HVAC unit configured to provide conditioned air to the cabin;
at least one thermoelectric module configured to alter environmental conditions in the cabin; and
a controller configured to selectively operate the compressor-based HVAC unit and the at least one thermoelectric module.

27. The work machine according to claim 26, wherein the at least one thermoelectric module includes:
a thermoelectric HVAC unit;
a steering wheel thermoelectric device;
one or more seat thermoelectric devices; and
one or more floor thermoelectric devices.

28. The work machine according to claim 27, wherein the thermoelectric HVAC unit shares vents with the compressor-based HVAC unit.

29. The work machine according to claim 26, wherein the at least one thermoelectric module includes high efficiency thermoelectric materials.

30. The work machine according to claim 26, wherein the controller is configured to:
obtain environmental temperature information from one or more sensors;
determine an operational mode for the at least one thermoelectric module based on the environmental temperature information;
determine an operational status for the compressor-based HVAC unit; and
supplement, based on the operational status of the compressor-based HVAC unit, operation of the compressor-based HVAC unit by operating the at least one thermoelectric module.
